(19) United States
(12) Patent Application Publication
(10) Pub. No.: US 2004/0096165 A1
(43) Pub. Date: May 20, 2004

(54) Integrated optical module interface

(76) Inventors: Darrell R. Childers, Hickory, NC (US); Russell J. Granger, Vale, NC (US); Joseph P. Howard, Hickory, NC (US)

Correspondence Address: MICHAEL L. LEETZOW,P.A., 5213 SHORELINE CIRCLE, STANFORD, FL, 32771, US

(21) Appl. No.: 10/300,368

(22) Filed: Nov. 20, 2002

(51) Int. Cl. G02B 6/42

(52) U.S. Cl. 385/92

(57) ABSTRACT

An integrated optical module interface is provided that includes an opening for a fiber optic connector with fiber optic guide pins and a lens opening. The integrated optical module interface also has a plurality of alignment elements to assist in aligning an optical device with the fiber optic connector. Latch elements are also provided to secure a fiber optic connector in the optical module interface. Preferably, the optical module interface is unitary, but could also be made of two components.

The present invention relates to an integrated optical module interface, and more particularly, an optical module interface that provides for a more reliable interface that combines several components into an integrated structure. The integrated optical module interface provides an interface between a fiber optic connector and an optical component, such as a VCSEL or detector array.

There are prior art devices including, for example, modules that have three separate components that must be assembled into a single assembly. The three components include a housing, a component that holds the lens array and fiber optic guide pins, and a piece that provides latches for the fiber optic connector. These three components must be combined, requiring additional steps and labor. Additionally, with three separate pieces, any errors in the structures are compounded, potentially making alignment of the optical components difficult, if not impossible.

Accordingly, the present invention is directed to an integrated optical module interface that substantially obviates one or more of the problems and disadvantages in the prior art. Additional features and advantages of the invention will be set forth in the description that follows, and in part will be apparent from the description, or may be learned by practice of the invention. The objectives and other advantages of the invention will be realized and attained by the apparatus and process particularly pointed out in the written description and claims, as well as the appended drawings.

### SUMMARY OF THE INVENTION

To achieve these and other advantages and in accordance with the purpose of the invention as embodied and broadly described herein, the invention is directed to an integrated optical module interface including a main opening for receiving a fiber optic connector, at least one integral fiber optic guide pin to align a ferrule in the fiber optic connector, a lens opening for receiving a lens array; and a plurality of alignment elements on an outer surface of the integrated optical module for aligning an optical device to be in optical communication with the fiber optic connector.

In another aspect, the invention provides for an integrated optical module interface comprising a main opening for receiving a fiber optic connector, at least one integral fiber optic guide pin to align a ferrule in the fiber optic connector, a lens opening for receiving a lens array; and integral latch elements to engage the fiber optic connector.

In yet another aspect, the invention is directed to an integrated optical module interface including a first component having a main opening for receiving a fiber optic connector and latch elements integral with the first component to engage the fiber optic connector; and a second component having at least one integral fiber optic guide pin to align a ferrule in the fiber optic connector and a lens opening for receiving a lens array, wherein the first and second components are connected to one another to form a single assembly.

It is to be understood that the foregoing general description and the following detailed description are exemplary and explanatory and are intended to provide further explanation of the invention as claimed.

The accompanying drawings are included to provide a further understanding of the invention and are incorporated in and constitute a part of the specification. The drawings illustrate several embodiments of the invention and together with the description serve to explain the principles of the invention.

### BRIEF DESCRIPTION OF THE DRAWINGS

FIG. 1 is a front perspective view of one embodiment of an integrated optical module interface according to the present invention;

FIG. 2 is a rear perspective view of the an integrated optical module interface of FIG. 1;

FIG. 3 is a elevational side view of the an integrated optical module interface FIG. 1; and

FIG. 4 is cross sectional view of the an integrated optical module interface of FIG. 2 along the line 4-4; and

FIG. 5 is cross sectional view of another embodiment of a integrated optical module interface according to the present invention.

### DETAILED DESCRIPTION OF THE INVENTION

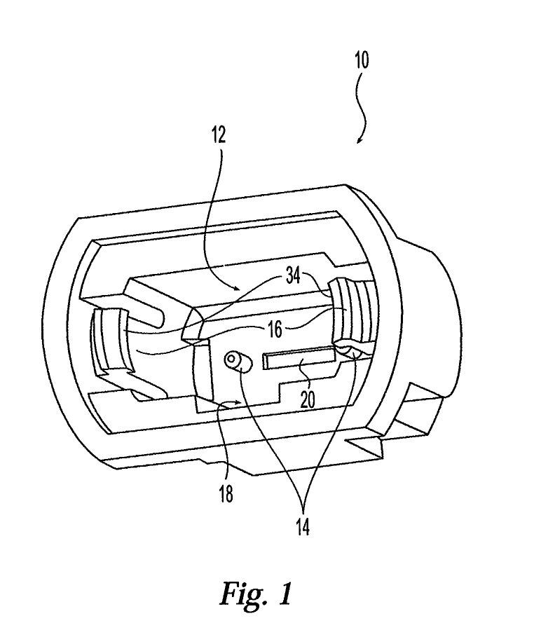

An integrated optical module interface 10 according to the present invention is illustrated in FIG. 1. The integrated optical module interface 10 has a main opening 12 for receiving a fiber optic connector (not shown) with two fiber optic guide pins 14 integral with the integrated optical module interface 10. The integrated optical module interface 10 also has two latch elements 16 on either side of the main opening 12 to engage a fiber optic connector. The main opening 12 also has a key way 18 to assist in aligning the fiber optic connector correctly in the main opening 12. In the illustrated embodiment, the main opening 12 is configured to engage an MTP connector, although the main opening 12 could be configured to engage any connector and still be within the scope of the invention.

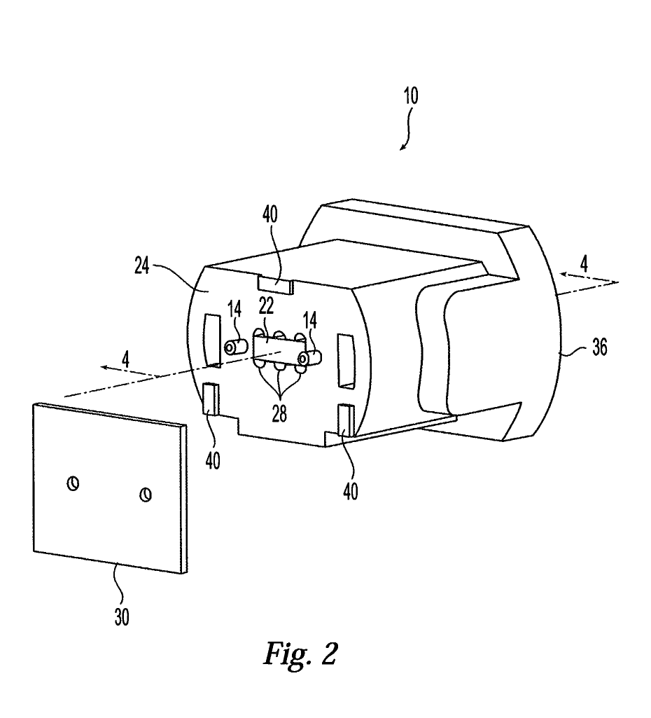

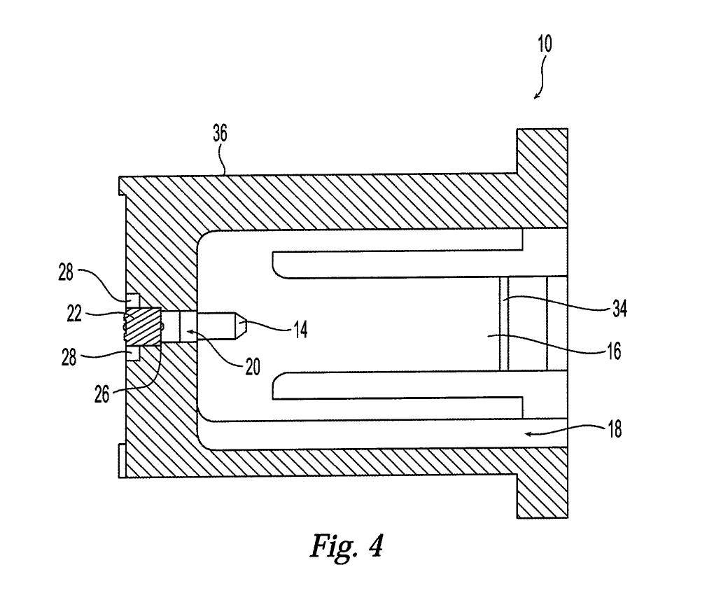

In the back of the integrated optical module interface 10 and the center of the main opening 12 is an lens opening 20 that is configured to receive a lens array 22. See also FIG. 2. The lens opening 20 is preferably accessible from the rear face 24 of the integrated optical module interface 10. As can be best seen in FIG. 4, the lens opening has a recessed ledge 26 around the lens opening 20 to assist in placing the lens array 22 in integrated optical module interface 10. Preferably, the lens opening 20 also has epoxy receptacles 28 adjacent the lens opening 20 to receive any excess epoxy that may result when the lens array 22 is epoxied in place. Without the epoxy receptacles 28, epoxy may build up around the lens opening 20 and cause the lens array 22 to be skewed in the lens opening 20 and not be correctly aligned with the optical connector and the optical component 30. Optical component 30 is illustrated as a VCSEL or detector array mounted on a substrate. While six epoxy receptacles are shown, other numbers and configurations are also possible. For example, there could be more or fewer epoxy receptacles, the epoxy receptacles could be of a different shape, including for example, square, rectangular, oval, or could run a portion or all the way around the lens opening 20.

On either side of the lens opening 20 are fiber optic guide pins 14. The fiber optic guide pins 14 are insert-molded into the integrated optical module interface 10. The fiber optic guide pins 14 are inserted into a mold for the integrated optical module interface 10 and the integrated optical module interface 10 is molded around the fiber optic guide pins 14. As a result, the fiber optic guide pins 14 are held tightly in the integrated optical module interface 10. Insert-molding the pins 14 into the integrated optical module interface 10 prevents the pins 14 from moving or falling out, thereby eliminating many of the problems of the prior art. For example, press fit fiber optic guide pins in the prior art devices would fall out, and those fiber optic guide pins that are epoxied in have issues with the epoxy not holding, the epoxy wicking to areas that prevent the connector from seating correctly, etc. Moreover, with the fiber optic guide pins 14 being insert-molded, the position of the fiber optic guide pins 14 can maintained within a 5 micron tolerance to lens opening 20. As is known to those skilled in the art, the fiber optic guide pins 14 are the points from which all optical relationships are governed. For example, the positions of the microholes in ferrules (and hence the positions of the optical fibers) are governed by the position of the fiber optic guide pins or guide pin holes in the ferrule. Similarly, the lens array 22 must be positioned in relationship to the fiber optic guide pins 14, or the individual lenses in the lens array will not align with the optical fibers in the connector. Hence, the lens opening 20 must be positioned in the integrated optical module interface 10 relative to the fiber optic guide pins 14.

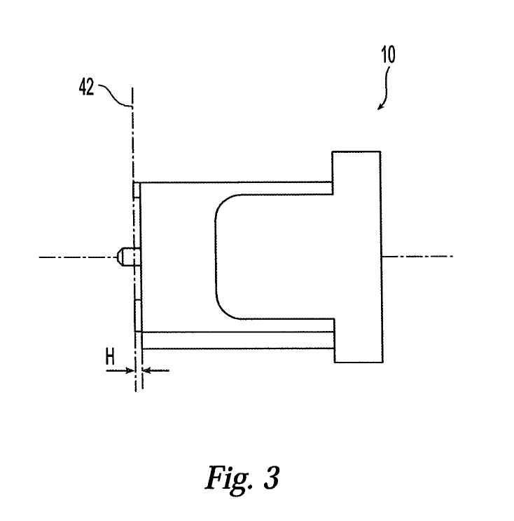

As seen in FIGS. 2 and 3, the fiber optic guide pins 14 may extend through the rear face 24 of the integrated optical module interface 10. By extending through the rear face 24, the fiber optic guide pins 14 may provide another structure on which to align and/or mount the optical component 30 or other components. While the fiber optic guide pins 14 may be used to assist in aligning or mounting the optical component 30, the optical component 30 must be physically aligned with the lens array 22 using special alignment equipment. The fiber optic guide pins 14 may also be flush with the rear face 24 of the integrated optical module interface 10.

The integrated optical module interface 10 also has two latch elements 16 on either side to engage a fiber optic connector. The latch elements 16 are integral with the integrated optical module interface 10. As can be seen in FIGS. 1 and 4, the latch elements 16 are attached within the integrated optical module interface 10 and are cantilevered. The latch elements 16 also have at least one projection 34 to engage a corresponding structure on a fiber optic connector. When the fiber optic connector is inserted into the main opening 12, the latch elements 16 flex outward toward the outer housing 36 of the integrated optical module interface 10. To allow for flexing, the latch elements 16 are offset from the outer housing 36 of the integrated optical module interface 10. When the corresponding structure on the fiber optic connector is inserted into the main opening 12, the projections 34 flex back toward the center of the main opening 12 and engage the corresponding structure, as is known in the art.

The integrated optical module interface 10 is preferably made of a flexible material that has a low thermal coefficient of expansion. This allows for the integrated optical module interface 10 to perform well at all temperatures, while allowing a sufficient amount of flexibility in the materials so that the latch elements 16 can move with the insertion and removal of the fiber optic connector. The material must also have sufficient rigidity that the fiber optic guide pins 14 are not subject to movement during use. As noted above, since the fiber optic guide pins 14 are the reference points for all other structures, movement of the fiber optic guide pins 14 could cause problems in optical communication, the problems ranging from a degradation of the signal to a total failure in transmission. Materials that have been found to be acceptable include glass-filled polyphenylene sulphide, carbon-filled polyphenylene sulphide, glass-filled polyetherimide, and carbon-filled polyetherimide.

The integrated optical module interface 10 also has a key way 18 to assist in orienting the fiber optic connector within the main opening 12. Since the MTP connector is a multifiber ferrule, the positioning of the optical fibers is important so that optical signals can be properly transmitted and received. As is known in the art, if the fiber optic connector is inverted, the transmitting fiber may be aligned with another transmitting fiber rather than with a receiving fiber, and the system will not work.

The integrated optical module interface 10 also has raised surfaces 40 that provide a plane 42 in which the optical component 30 may be disposed. The plane 42 is used herein as a reference plane that is parallel to the rear face 24 of the integrated optical module interface 10 and lens array 22. The three raised surfaces 40 are preferably integrally molded into integrated optical module interface 10, but could be later added. While the three raised surfaces 40 are illustrated as being disposed with one at the top and one on each side of the bottom portion of integrated optical module interface 10, they could be placed anywhere on the rear face 24 and could be of any number as long as they provide a plane 42 for the optical component 30. As noted above, the raised surfaces 40 are to assist in mounting at least a portion of optical component 30 in plane 42, which is preferably parallel to the lens array 22. It should be noted that the distance of the plane 42 relative to the rear face 24, and hence the height H of the raised surfaces 40, is a function of the optical component 30 and the lens array 22. Depending on the specific requirements for these components, the raised surfaces 40 could be of any height. Regardless of the distance of the plane 42 from rear face 24, the raised surfaces 40 preferably are within 10 microns from the plane 42 to assist in orienting the optical component 30. There are typically six axes that are of concern when aligning the optical component 30 to the lens array 22: tip, tilt, the z-axis, the x- and y-axis, and rotation in x-y plane. The raised surfaces 40 eliminate alignment issues in three axes for the optical component 30: tip, tilt, and z-axis (distance from the rear face 24 and lens array 22). The alignment for the other axes are performed in a manual fashion.

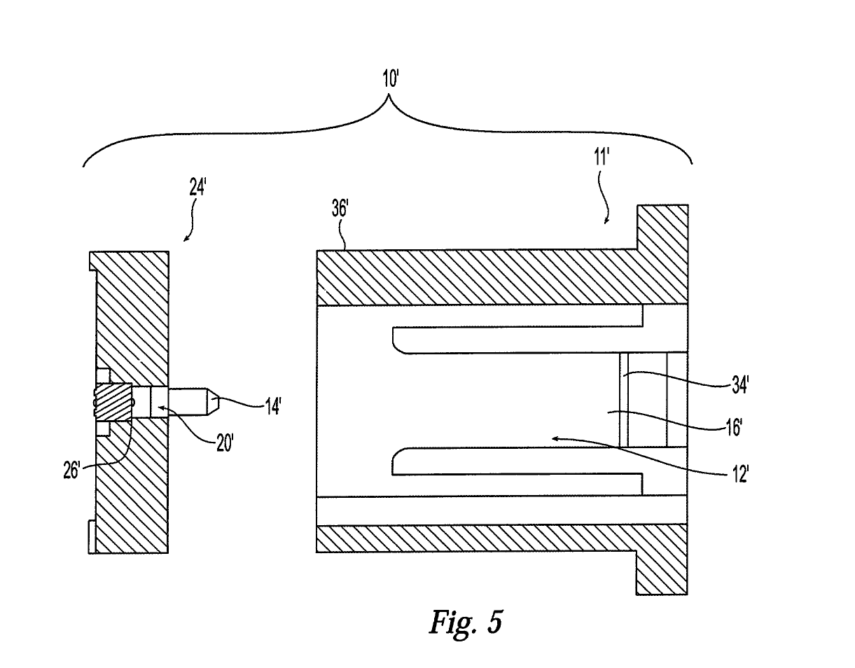

Another embodiment of an integrated optical module interface 10′ is illustrated in FIG. 5, which has two components. The first component is a front housing 11′ that contains latch elements 16′ with projections 34′ and opening 12′ and the second component is a rear panel 24′ that includes a lens opening 20′ with a recessed ledge 26′ and insert-molded fiber optic guide pins 14′. Both components are molded separately and later assembled. The components can be attached to one another by epoxy, ultrasonic welding, and mechanical fasteners. Since the lens opening 20′ and the fiber optic guide pins 14′ are in the same component, the important spatial relationship between them may be maintained. While this embodiment has two components rather than the unitary module in the first embodiment, there is still a reduction in the labor, number of parts, and cost, while still providing accuracy.

It will be apparent to those skilled in the art that various modifications and variations can be made in the integrated optical module interface of the present invention without departing from the spirit or scope of the invention. Thus, it is intended that the present invention cover the modifications and variations of this invention provided they come within the scope of the appended claims and their equivalents.

We claim:

1. An integrated optical module interface comprising:
a main opening for receiving a fiber optic connector;
at least one integral fiber optic guide pin to align a ferrule in the fiber optic connector;
a lens opening for receiving a lens array; and
a plurality of alignment elements on an outer surface of the integrated optical module for aligning an optical device to be in optical communication with the fiber optic connector.

2. The integrated optical module interface of claim 1, further comprising integral latch elements to engage the fiber optic connector.

3. The integrated optical module interface of claim 2, wherein the latch elements have at least one projection to engage the fiber optic connector.

4. The integrated optical module interface of claim 1, wherein the at least one fiber optic guide pin comprises two fiber optic guide pins.

5. The integrated optical module interface of claim 4, wherein the guide pins are insert-molded into the receptacle.

6. The integrated optical module interface of claim 4, wherein the fiber optic guide pins extend through a rear face of the receptacle.

7. The integrated optical module interface of claim 4, wherein the fiber optic guide pins are flush with a rear face of the receptacle.

8. The integrated optical module interface of claim 1, wherein the lens opening is accessible from a rear face of the receptacle.

9. The integrated optical module interface of claim 4, wherein the lens opening has a predetermined position relative to the fiber optic guide pins.

10. The integrated optical module interface of claim 9, wherein an actual position of the lens opening is within 5 microns of the predetermined position relative to the fiber optic guide pins.

11. The integrated optical module interface of claim 1, wherein the plurality of alignment elements comprise at least three raised surfaces on a rear face of the integrated optical module interface to engage an optical component.

12. The integrated optical module interface of claim 11, wherein each of the at least three raised surfaces lie within a predetermined distance from a reference plane.

13. The integrated optical module interface of claim 11, wherein the predetermined distance is less than 10 microns.

14. The integrated optical module interface of claim 11, wherein each of the at least three raised surfaces are a predetermined distance from a rear surface of the receptacle.

15. The integrated optical module interface of claim 1, further comprising a keyway in the main opening to assist in orienting a fiber optic connector.

16. The integrated optical module interface of claim 1, wherein the integrated optical module interface is made from a material selected from one of the materials in the group of glass-filled polyphenylene sulphide, carbon-filled polyphenylene sulphide, glass-filled polyetherimide, and carbon-filled polyetherimide.

17. An integrated optical module interface comprising:
a main opening for receiving a fiber optic connector;
at least one integral fiber optic guide pin to align a ferrule in the fiber optic connector;
a lens opening for receiving a lens array; and
integral latch elements to engage the fiber optic connector.

18. An integrated optical module interface comprising:
a first component having a main opening for receiving a fiber optic connector and latch elements integral with the first component to engage the fiber optic connector; and
a second component having at least one integral fiber optic guide pin to align a ferrule in the fiber optic connector and a lens opening for receiving a lens array, wherein the first and second components are connected to one another to form a single assembly.

19. An integrated optical module interface comprising:
an outer housing;
a main opening in the outer housing for receiving a fiber optic connector; and
at least one integral fiber optic guide pin to align a ferrule in the fiber optic connector.
